(19) United States
(12) Patent Application Publication
(10) Pub. No.: US 2012/0145271 A1
(43) Pub. Date: Jun. 14, 2012

(54) CURABLE PRESSURE PIPE LINER

(76) Inventors: Christopher McKeller, San Diego, CA (US); Rene Quitter, Kirchen (DE)

(21) Appl. No.: 13/326,151

(22) Filed: Dec. 14, 2011

Related U.S. Application Data
(60) Provisional application No. 61/546,998, filed on Oct. 13, 2011.
(60) Provisional application No. 61/423,057, filed on Dec. 14, 2010.

(51) Int. Cl. F16L 55/162

(52) U.S. Cl. 138/98

(57) ABSTRACT

A curable liner tube, once inserted into a pipe and cured, can withstand relatively high internal pressures as well as relatively high external pressures, and can also resist destructive effects from liquids and gases with which the pipe and liner tube come in contact. The liner tube is sufficiently pliable in an uncured condition to lie substantially flat and to be substantially circular in cross section in an expanded state, and comprises an outer strengthening system that is configured for placement in a pipe interior and that changes from a pliable condition to a hardened condition upon curing, and a membrane system disposed inwardly relative to the outer strengthening system when placed in the pipe interior, comprising an impermeable sealing film having a facing surface that faces the interior of the pipe.

### CROSS-REFERENCE TO RELATED APPLICATION(S)

This application claims priority to U.S. Provisional Patent Application No. 61/546,998, filed Oct. 13, 2011 and U.S. Provisional Patent Application No. 61/423,057 filed Dec. 14, 2010 both of which are incorporated herein by reference.

### BACKGROUND

1. Field of the Invention

The present invention relates generally to tube liners for pipes and systems under raised pressure, and methods for the manufacture of tube liners, and more particularly to cured pressure pipe liners.

2. Description of the Related Art

Much of the infrastructure in cities around the world was installed many years ago, and is now beginning to age and decay. Pipes that are pressurized are designed to transport gases and liquids at pressures greater than atmospheric pressure. Pressurized pipes are at greater risk for aging and decay because of the increased structural demands due to the pressure. For example, aging pipes for water, gas, oil, and the like may begin to leak due to cracks/damage in the walls of the pipes and in connections between pipe segments. A leak in a pressurized pipe is especially troubling because the increased pressure can result in a much greater amount of material leaving the pipe and leaking into the environment. Such leaks are not acceptable and can be very costly to remedy.

Many pipes carry gases or liquids that are caustic, corrosive, or otherwise dangerous if released from the pipeline. Other pipes may carry a mixture of substances including gases, liquids, and solid matter. The gases, liquids, and mixtures may or may not be carried under pressure. References herein to gases and liquids being carried by pipes should be understood to include mixtures of gases, liquids, and solid matter. In addition to substances being carried by the pipe, gases and liquids may be present in the environment around the pipe. The destructive effects to which such pipes are subjected by such gases and liquids may include, for example, corrosion, abrasion, disintegration, ablation, erosion, deterioration, and the like. Pipes that are subject to such destructive effects must be designed to resist the effects of the gases or liquids with which they come in contact.

Many pressurized pipes, and many pipes carrying destructive or dangerous substances, are buried underground. The underground placement can keep the pipeline out of harm's way and can reduce the effects of a leak. In can be extremely expensive and time consuming to replace underground pipes. The earth around the pipe must be excavated, and the pipe must be removed from the ground. The new pipe segment must then be placed in the excavation site, joined and sealed to adjacent pipe segments, and then buried again. All of these tasks are very time consuming and require heavy machinery and many workers, thus making the replacement process very expensive.

As an alternative to excavating the pipe, it is possible replace/repair the pipe from the inside out using a curable fabric liner. The liner, typically constructed of fiberglass or felt, is impregnated with a curable resin and then inserted or inverted (i.e. turned inside-out) into the interior of the pipe. By using a fluid medium under pressure (e.g. gases or liquids, including air or water), the liner is pressed against the inner walls of the existing pipe. Once the resin cures (due to a catalyst of heat, light, or chemical), the liner changes to a hardened condition and is rigid, and the pressure source can be removed, leaving a new gas/liquid-tight inner wall of the pipe.

Although the procedure for using a curable fabric liner can eliminate the need for excavating a damaged pipe, curable fabric liners are not generally able to withstand both increased pressure and destructive forces from substances including gases and liquids. There is a need for curable fabric liners that have good burst resistance to increased pressures and that can withstand destructive effects from the liquids and gases with which they come in contact.

### SUMMARY

A curable liner tube in accordance with this disclosure, once inserted into a pipe and cured, can withstand relatively high internal pressures (burst resistance) as well as relatively high external pressures (compression resistance), and can also resist destructive effects from liquids and gases with which the pipe and liner tube come in contact. As described further below, the liner tube is sufficiently pliable in an uncured condition to lie substantially flat and to be substantially circular in cross section in an expanded state, and the liner tube comprises an outer strengthening system comprising a curable material that is configured for placement in a pipe interior and that changes from a pliable condition to a hardened condition upon curing, and a membrane system disposed inwardly relative to the outer strengthening system when placed in the pipe interior, comprising an impermeable sealing film having a facing surface that faces the interior of the pipe.

The curable liner tube is a multiple-layer elongated tube that fits within the pipe and that includes a membrane system surrounded by an outer strengthening system. The membrane system provides the inner-most liner tube material that carries the gas or liquid of the pipe and provides an impermeable barrier that prevents any gas or liquid from passing through the membrane system. The outer strengthening system provides liner tube burst resistance and compression resistance. Prior to curing, the liner tube is in a relatively pliable condition. In the pliable condition, the liner tube may be folded flat and stored, for easier transportation and easier insertion into a pipe. After insertion into the pipe, the curable liner tube may be inflated so as to be pressed against the inner walls of the pipe and conform to the inner surface of the pipe, thereby providing an internal passage for carrying gas and liquids, and then the liner tube may be cured so as to change to a hardened condition. When in the hardened condition, the liner tube can resist the destructive effects of liquids and gases with which it comes in contact, and provides good burst resistance to increased pressures and good compression resistance, as well as good abrasion resistance.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a cross-section through a pipe with a cured liner tube in place, showing the membrane system and strengthening system of the liner tube.

FIG. 2 is a cross-section showing the configuration of one embodiment of the membrane system illustrated in FIG. 1, prior to curing.

FIG. 3 is a cross-section of a membrane system having the construction illustrated in FIG. 2, prior to curing.

FIG. 4 is a cross-section showing the configuration of an alternative embodiment of the membrane system illustrated in FIG. 1, prior to curing.

FIG. 5 is a cross-section of a membrane system having the construction illustrated in FIG. 4, prior to curing.

FIG. 6 is a cross-section of a membrane system having the construction illustrated in FIG. 4, prior to curing, with a seam area closed by tape.

FIG. 7 is a cross-section of a liner tube as illustrated in FIG. 1, prior to curing, showing the membrane system and strengthening system in the folded condition, prior to curing.

FIG. 8 is a cross-section showing the configuration of an alternative embodiment of the membrane system illustrated in FIG. 1, prior to curing.

FIG. 9 is a cross-section through a pipe with a cured liner tube in place, in which the membrane system has the construction illustrated in FIG. 8.

FIG. 10 is a cross-section through a pipe with a cured liner tube in place, in which the liner tube includes an outer strengthening system, membrane system, and inner strengthening system.

FIG. 11 is a cross-section of a membrane system showing a welding technique for the curable liner tube.

FIG. 12 is a cross-section of a membrane system showing an alternative welding technique for the curable liner tube.

### DETAILED DESCRIPTION

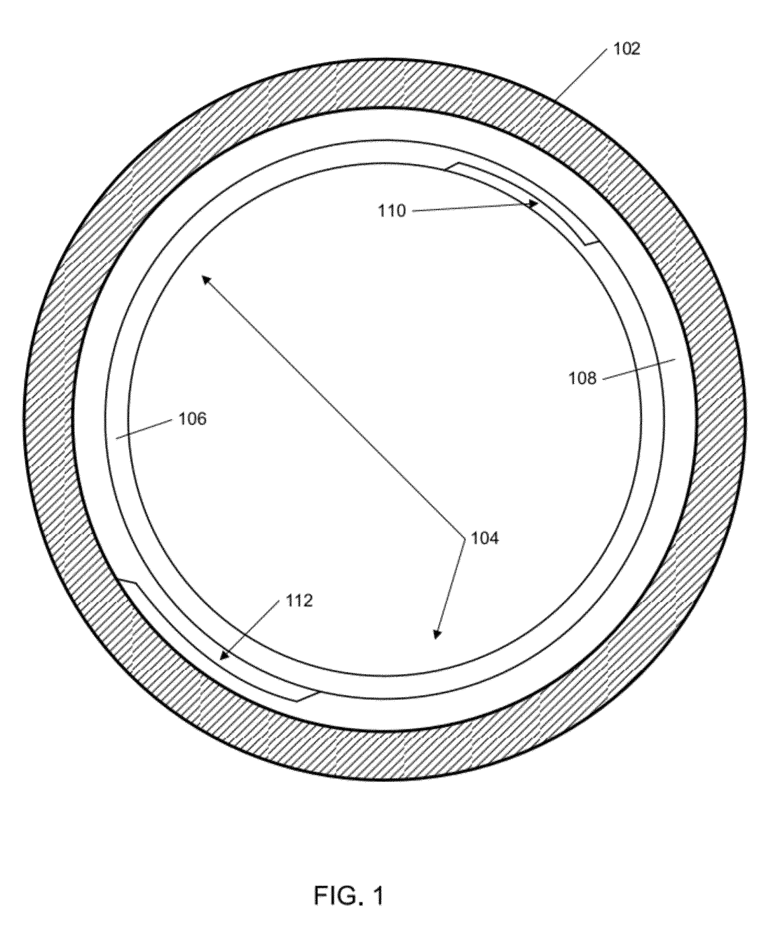

FIG. 1 shows a cross-section through a pipe 102 that is lined with a liner tube as disclosed herein. The pipe 102 is illustrated in FIG. 1 with a curable liner tube 104 in a hardened condition, after curing. The liner tube 104 includes an impermeable membrane system 106 and an outer strengthening system 108. The liner tube 104 is shown in FIG. 1 in the cured condition, but unless otherwise noted below, the construction details of the liner tube apply to both the cured and uncured conditions. The membrane system 106 carries the gas or liquid of the pipe 102 and is impermeable, so that it prevents any gas or liquid in the interior space enclosed by the membrane system from passing to the outside. The membrane system also prevents passage of substances outside the membrane system to within the membrane system space. The outer strengthening system 108 comprises a material that is impregnated with a curable resin or comprises some other curable material such that the outer strengthening system is pliable and can be manipulated prior to curing, and then changes to a hardened condition after curing. The outer strengthening system provides pressure resistance, as when the pipe 102 is called upon to carry gas or liquid at elevated pressures greater than atmospheric pressure. In this way, the outer strengthening system 108 contributes to burst resistance and compression resistance of the cured liner tube 104.

The liner tube 104 is constructed from multiple overlapped sheets that are cured after the liner tube is placed within the interior of the pipe 102. In the uncured condition, the overlapped sheets of the liner tube are placed in the pipe and then the liner tube is inflated, in a manner known to those skilled in the art. The schematic representation of FIG. 1 shows a portion 110 of the membrane system 106 with overlapped sheets and shows a portion 112 of the strengthening system 108 with overlapped sheets. Details of the overlapped sheet construction are omitted from FIG. 1 for clarity but are described further below and will be understood by those skilled in the art. See also, for example, U.S. patent application Ser. No. 12/505,050 filed Jul. 17, 2009 in the name of R. Quitter, incorporated herein by reference.

The liner tube 104 is in a relatively pliable condition prior to curing and can be manipulated by hand. For example, as described further below, the liner tube may be folded and stored in a flat condition prior to curing, for easier transportation and easier insertion into the pipe 102. At a job site, the curable liner tube may be unfolded or otherwise deployed into the pipe. After insertion into the pipe, the curable liner tube may be inflated so as to be pressed against the inner walls of the existing pipe to conform to the pipe interior surface and provide an internal passage. Common inflation techniques may be used to inflate the curable liner tube 104 once it is in place within the pipe 102. After the liner tube is in place and inflated within the pipe, the liner tube may be cured so as to change to the hardened condition. When in the hardened condition, the liner tube can resist the destructive effects from the materials with which they come in contact. The cured liner tube exhibits good burst and compression resistance, as well as good abrasion resistance. In this way, the curable liner tube can be used to line pipes, such as to effectuate repair or reinforcement of pipes, and can provide good burst resistance to increased pressures and resistance to destructive effects from the liquids and gases with which they come in contact.

The liner tube 104 is cured according to the properties of the materials used for the membrane system 106 and outer strengthening system 108. For example, the outer strengthening system may comprise one or more layers of fiberglass material embedded with a resin that is cured by ultraviolet (UV) light. The UV light wavelength spectrum used to cure resin is typically between 365 nm and 410 nm. After the curable pipe liner tube 104 is placed within the pipe 102 and is inflated, a source of UV light is passed along the length of the pipe so as to pass UV light through the membrane layer 106 and into the outer strengthening system 108, thereby changing the outer strengthening system from the pliable condition into the hardened condition. It should be apparent that, in such an embodiment, the membrane system 104 must permit the passing of UV light with minimal diffusion. See, for example, the additional details described in the U.S. Ser. No. 12/505,050 application to R. Quitter referenced above. Curable materials and corresponding curing techniques other than those based on UV light may be used. For example, the outer strengthening system may be configured so it is cured by techniques using heat, chemical, electromagnetic energy, and the like. The membrane system will be selected accordingly, to cooperate with the particular curing technique for the outer strengthening system.

The membrane system 106 provides an impermeable barrier to passage of gases and liquids that are carried within the pipe 102. The membrane system, and the outer strengthening system prior to curing, should be sufficiently pliable to conform to the interior surface of the pipe. That is, upon inflation of the liner tube 104 prior to curing, the membrane system and outer strengthening system should conform to the interior surface of the pipe. After curing, the membrane system should conform to the hardened outer strengthening system. Any separation or pockets between the two can be problematic and must be avoided. Separation and pockets may be avoided by bonding the membrane system to the outer strengthening system during curing, or by holding the membrane against the outer strengthening system. Configurations to achieve these goals are described further below.

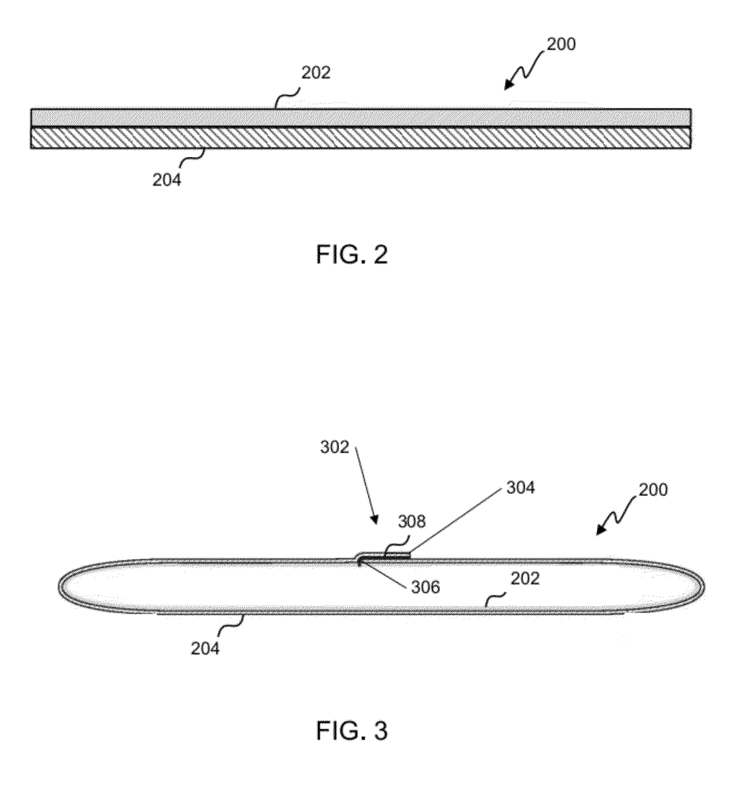

FIG. 2 shows a portion of an embodiment of the membrane system 106 illustrated in FIG. 1 prior to curing. The FIG. 2 embodiment 200 of the membrane system includes two layers, comprising a sealing film 202 and an attachment layer 204. The sealing film may comprise a plastic sheet, and the attachment layer may comprise one or more textile sheets having absorbent properties. In the two-layer configuration, the attachment layer 204 preferably has qualities of being pliable for easier handling before curing and being configured for receiving sealing and curable materials, such as curable resin, and binding to the outer strengthening system 108 upon curing. For example, the attachment layer may be constructed from materials such as fiberglass, Kevlar™, polyamide fibers, non-woven polyester felt, fleece, “Sontara” brand hydroentangled fabric (HEF) that is available from E.I. du Pont de Nemours and Company (“DuPont”) and the like. The attachment layer is typically configured to have a textured surface, such as comprising a textile, to encourage mechanical binding between the attachment layer, the curable material, and the outer strengthening system. The sealing film 202 preferably does not degrade with exposure to curable materials, such as curable resin, that are used in connection with the attachment layer. The sealing film preferably does not bind to itself or to other materials as a result of exposure to the curable materials used with the attachment layer.

The sealing film 202 is typically bonded to the attachment layer 204 so as to resist the two from being pulled apart. The bonding effect is typically achieved by lamination of the two materials. The attachment layer may have a construction that provides, for example, a textured construction that can absorb liquids such as curable resins. Other techniques known to those skilled in the art may be used to ensure that the sealing film and attachment layer are not pulled apart prior to curing.

The attachment layer 204 in the FIG. 2 embodiment of the membrane system 200 may comprise one or more sheets of a plastic textile or the like, impregnated with a curable resin. The textile sheets may be impregnated with resin at a suitable time, such as at the time of production, or at the job site prior to insertion of the liner tube in the pipe. When cured, the resin of the membrane system changes from a pliable condition to a hardened condition.

FIG. 3 shows the membrane system 200 of FIG. 2 in the folded condition, prior to curing. The membrane system 200 comprises one or more sheets of sealing film 202 bound to the attachment layer 204, and the sheets are folded over one another so as to be overlapped along a seam area 302. Once in place within a pipe and inflated, the membrane system forms an enclosed space. FIG. 3 shows that the overlapped seam area 302 is formed when one edge 304 of the membrane system is folded over on top of the opposite edge 306 of the membrane system. That is, the seam area 302 extends along the length of the sheets comprising the membrane system. It should be apparent that the overlapped seam area occurs from the width of the membrane system in the substantially flat uncured condition being greater than the inner circumference of the strengthening system when installed.

In FIG. 3, a sealant 308 is included to assist with holding the overlapped edges 304, 306 closed during handling of the liner tube, prior to curing. The sealant may comprise, for example, an adhesive material that tends to keep the overlapped edges in place during handling prior to curing, or some other material that maintains the overlapped edges 304, 306 closed prior to curing. Alternatively, the overlapped sheet edges 304, 306 of the membrane system 200 may be held closed without a sealant, and welding techniques may be used instead, or the extent of the overlapped area and the weight of the sheets themselves may be configured to be sufficient for maintaining the overlapped sheets closed, prior to curing. For pipes of most diameters and with typical materials for the membrane system, for example, an overlapped seam area 302 having a width of approximately 3 inches (about 7.5 cm) is sufficient to maintain the overlapped edges 304, 306 closed during handling without sealing material. After curing, the closed seam forms a barrier for the passage of liquids and gases through the overlapped seam into or out of the membrane system.

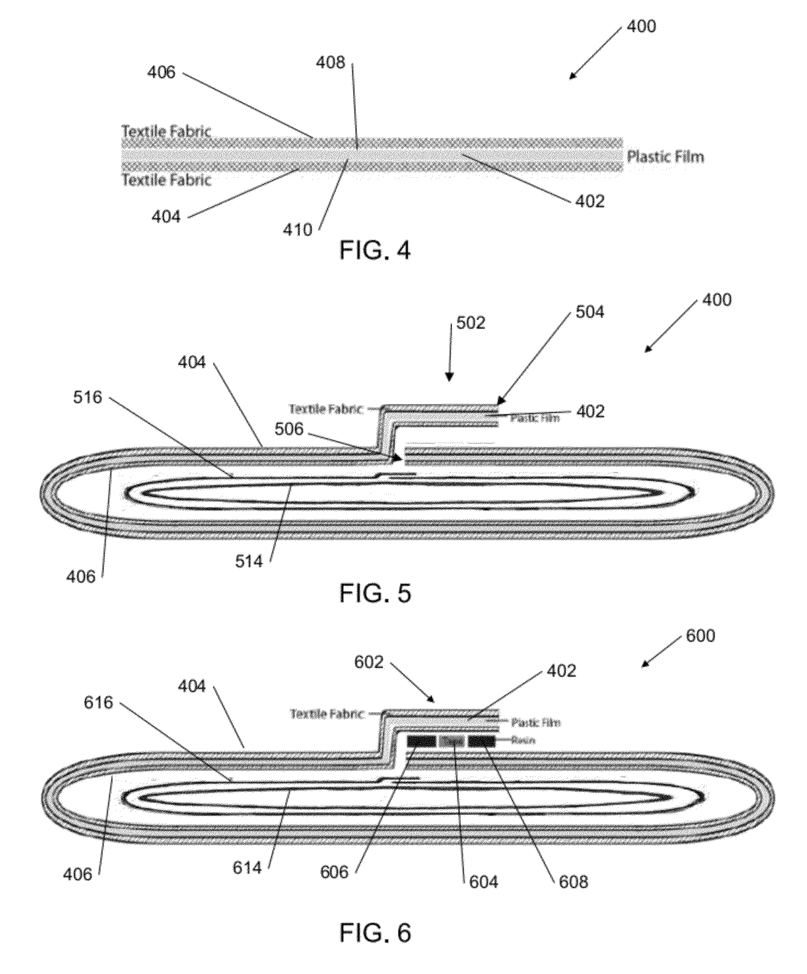

FIG. 4 shows a portion of an embodiment of the membrane system 106 illustrated in FIG. 1, prior to curing. In the FIG. 4 embodiment, as with the previous embodiment, the membrane system 400 includes a sealing film and an attachment layer. In FIG. 4, however, the sealing film comprises an impermeable material such as a plastic sheet 402, and the attachment layer comprises an outer layer absorbent textile 404 on an outer-facing surface of the sealing film (adjacent the outer strengthening layer 108) and an inner layer absorbent textile 406 on an inside-facing surface of the sealing film. When the membrane system 400 is in place within the pipe, the inner layer absorbent textile 406 faces the interior of the pipe, and the outer layer absorbent textile 404 faces outwardly and is pressed against the outer strengthening system 108 (FIG. 1) upon inflation of the membrane system. Thus, an inner surface 408 of the plastic sheet 402 is adjacent the inner layer absorbent textile 406 (shown as the top layer in FIG. 4) and an outer surface 410 of the plastic sheet 402 is adjacent the outer layer absorbent textile 404 (shown as the bottom layer in FIG. 4).

The absorbent textile 404 at the bottom layer of FIG. 4 and the absorbent textile 406 at the top layer of FIG. 4 may both have the same construction and may comprise, for example, textile fabric such as the “Sontara” brand HEF from DuPont. Alternatively, the absorbent textile 404, 406 may be constructed of different materials, in accordance with different operating environments or different performance requirements. For example, the inner facing absorbent textile 406 may interface with whatever gas or liquid is being transported in the pipe 102, or it may interface with an inner tube or other conduit for transporting the gas or liquid within the pipe, whereas the outer facing absorbent textile 404 is adjacent to the outer strengthening system 108. In view of these different operating environments, the inner facing textile 406 may be constructed of, for example, a felt or fiberglass material, and the outer facing textile 404 may be constructed of, for example, a polyester or “Sontara” fabric. The absorbent textiles 404, 406 are impregnated with a curable resin, indicated in FIG. 4 by cross-hatching. The absorbent textiles, after the resin is cured, change from a flexible condition to a hardened condition, and in the hardened condition, they provide pressure resistance for carrying gases and liquids under pressure without bursting. The absorbent textiles 404, 406 help the plastic film 402 to maintain its shape and resist wrinkling during handling and installation.

FIG. 5 shows the membrane system 400 of FIG. 4 in the folded condition, prior to curing. The membrane system 400 comprises the sealing film 402 and attachment layers 404, 406 folded over one another so as to be overlapped along a seam area 502. As with the prior embodiment, once in place within a pipe and inflated, the membrane system 400 forms an enclosed space. FIG. 5 shows that the overlapped seam area 502 is formed when one edge 504 of the membrane system is folded over on top of the opposite edge 506 of the membrane system.

That is, the seam area 502 extends along the length of the sheets comprising the membrane system. As with the previously described embodiment, the outer strengthening layer 108 (FIG. 1) is impregnated with a curable resin or other curable material such that the outer strengthening layer is pliable and can be manipulated prior to curing, and then changes to a hardened condition after the resin is cured. After curing, the closed seam 502 forms a barrier for the passage of liquids and gases through the overlapped seam into or out of the membrane system.

The width of the seam 502 with respect to the elongated liner tube should be sufficient to prevent seepage of substances from the interior of the membrane system to the outside, after curing, and should be sufficient to prevent seepage of substances from outside the membrane system to the interior of the membrane system, after curing. A suitable width for the seam 502 will generally be at least 2% of the circumference of the pipe 102, with approximately at least an additional 3.0 inches (7.5 cm) in circumferential extent after the liner tube is inflated. For example, a pipe having a diameter of 8.0 inches has a circumference of approximately 25.0 inches, and will generally have a liner tube with a seam area 502 having a circumferential length of at least approximately 2.5 inches (2%*25.0+2.0) when inflated within the pipe. Any combination of seam width and closing material may be used, so long as the seam is maintained closed during handling and transportation, and during inflation and installation.

The seam area 502 may be maintained closed during handling, for example, by a sealant applied between the overlapped edges 504, 506 in the seam area. The sealant may comprise a curable resin or adhesive material or the like that tends to maintain the overlapped edges in a closed condition during handling and prior to curing. Alternatively, the overlapped edges 504, 506 may be maintained closed without a sealant or adhesive. For example, welding techniques may be used instead of sealant, or the width of the overlapped seam area 502 may be sufficient, given the weight of the sealing film 402 and absorbent textiles 404, 406 themselves, to maintain the edges closed, one on top of the other. After curing, the closed seam forms a barrier for the passage of liquids and gases through the overlapped seam area into or out of the membrane system. In FIG. 5, the overlapped edges 504, 506 are shown lifted apart for illustration, but it should be understood that in actuality the edges will lie flat, one on top of the other.

FIG. 5 also shows an inner tube 514 constructed of foil or plastic that is carried within a carrier such as fiberglass 516. The inner tube 514 is provided for easier handling of the tube liner prior to curing, and is removed after curing. The fiberglass 516 may be constructed to be chemically resistant to the gas or liquid being carried in the pipe, or may have other desirable physical properties for exposure to the gas or liquid being carried. The inner tube is useful to prevent curable materials in opposed surfaces of the membrane system from dripping or otherwise coming into contact with each other.

As noted above, the membrane system 400 may comprise a plastic film 402 laid between two absorbent textiles 404, 406. More particularly, the plastic film can be laminated between two thin layers of absorbent textile fabric that may comprise, for example, the “Sontera” brand HEF referenced above. Alternatively, any other absorbent textile fabric may be used that will not degrade when it comes into contact with uncured resin. Any combination of techniques such as mentioned above for maintaining the seam 502 closed before curing may be used, such as taping, adhesive, or welding techniques, or alternatively, the extent of the overlap in the seal area may be sufficient to maintain the membrane system in place during construction and installation. Curable resin may be applied in the seam area 502 during construction of the curable liner tube, to ensure full saturation of substantially the full width of the seam area, or a combination of all closing techniques may be used, or not at all.

FIG. 6 shows the membrane system 400 of FIG. 4 in the folded condition, prior to curing, in which the FIG. 6 membrane system 600 has a seam area 602 with overlapped edges of the membrane system maintained in a closed condition by a sealant comprising a combination of tape 604 and curable resin 606, 608. The tape 604 is illustrated as straddled by two strips or ribbons of curable resin, one strip 606 along the inner edge of the seam area 602 and the other strip 608 along the outer edge of the seam area. One strip of resin may be used without the other, depending on the intended usage environment, so long as the single strip of resin is sufficient to maintain the seam area 602 closed during handling and transportation and inflation (installation) prior to curing.

FIG. 6 also shows an inner tube 614 constructed of foil or plastic that is carried within a carrier such as fiberglass 616. The inner tube 614 is provided for easier handling of the tube liner prior to curing, and is removed after curing. The fiberglass 616 may be constructed to be chemically resistant to the gas or liquid being carried in the pipe, or may have other desirable physical properties for exposure to the gas or liquid being carried. The inner tube is useful to prevent curable materials in opposed surfaces of the membrane system from dripping or otherwise coming into contact with each other.

Using the construction described above, the cured liner tube is able to withstand extreme high pressures of varying degree, depending on the thickness of the liner tube. The curable liner tube includes a membrane system comprised of a sealing film and absorbent textile that are overlapped along the length of the curable liner tube, forming a seal area. The absorbent textile in the seal area may be saturated with a sealing material that can be cured to prevent passage of liquids and gases through the overlapped seal area, while resisting destructive effects from the liquids and gases. Other optional details of construction can provide additional features. For example, the membrane system surrounds an inner tube, such as an inner foil and an inner fiberglass layer. The foil layer of the inner tube eases handling of the curable liner tube for installation and is removed after the curable liner tube is located within a pipe, prior to curing.

As noted above, the curable pressure liner tube includes a membrane system and an outer strengthening system. The outer strengthening system may include one or more layers of sheets such as fiberglass, felt, or other materials that will absorb a curable material so as to be uniformly impregnated with the curable material. After curing, the outer strengthening system changes from a pliable condition to a hardened condition, and provides burst resistance. The curable material, such as resin, contributes to abrasion resistance.

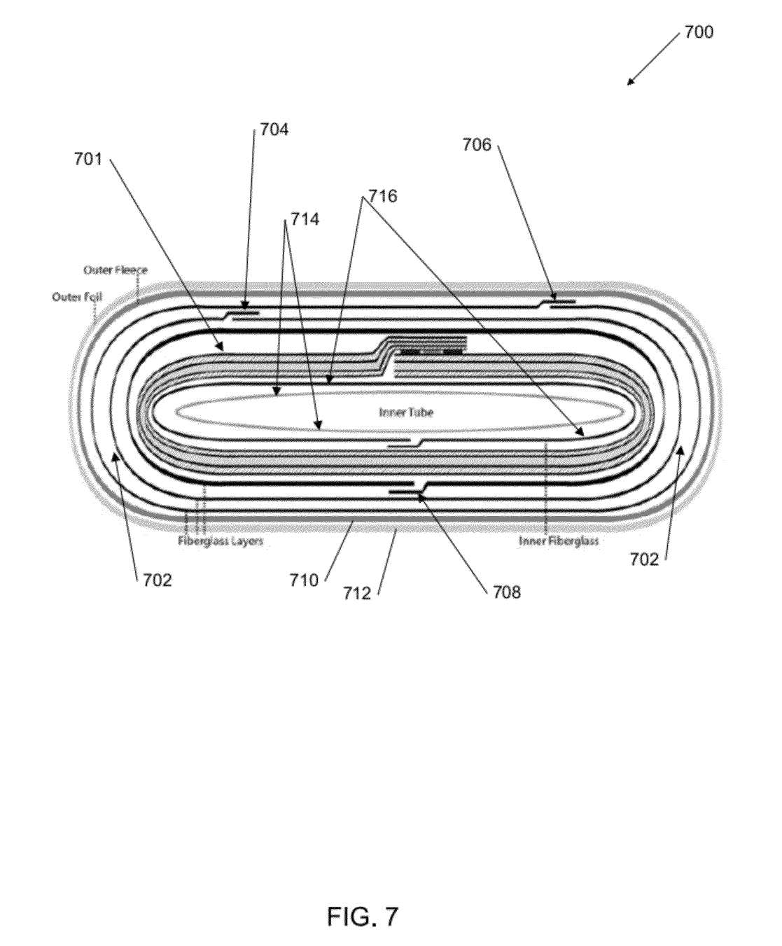

FIG. 7 shows a curable pressure tube liner 700 with an inner membrane system 701 enclosed within and surrounded by an embodiment of the outer strengthening system 702 that includes layers of fiberglass sheets, each of which is overlapped along a seam area. Several of the seams 704, 706, 708 are identified in FIG. 7 and are spaced apart circumferentially. The number of layers of fiberglass folded over the membrane system 701 will be selected in accordance with the user's design strength requirements and the qualities of the fiberglass layers themselves. FIG. 7 also shows an outer fleece layer 710 surrounding the outer strengthening system 702 and shows a UV-resistant outer foil layer 712 surrounding the outer fleece. The outer fleece and outer foil layers contribute to easier handling, transportation, and installation of the curable pipe liner. The outer foil provides UV-resistant properties for preserving the curable resin in the uncured condition. An inner tube 714 constructed of foil or plastic is carried within a carrier such as fiberglass 716. The inner tube 714 is provided for easier handling of the tube liner prior to curing, and is removed after curing. The fiberglass 716 may be constructed to be chemically resistant to the gas or liquid being carried in the pipe, or may have other desirable physical properties for exposure to the gas or liquid being carried.

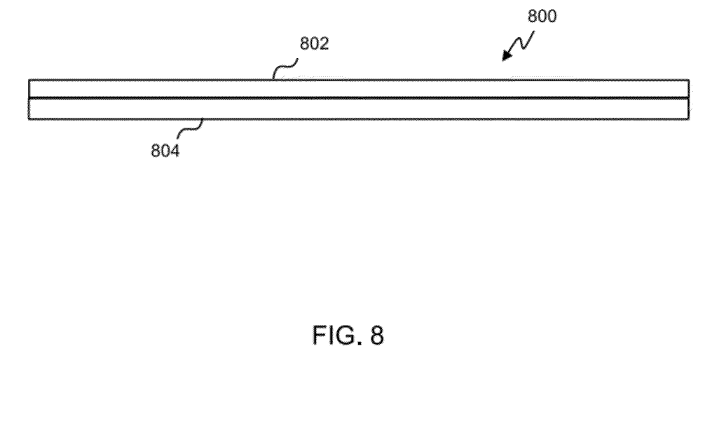

FIG. 8 is a cross-section showing the configuration of an alternative embodiment of the membrane system 106 illustrated in FIG. 1, prior to curing. FIG. 8 shows a portion 800 of the membrane system having two layers 802, 804. The FIG. 8 portion 800 includes a sealing film layer 802 and an attachment layer 804. The attachment layer 804 is configured to react with the curable resin in the outer strengthening system 108 (FIG. 1) so as to form a bond between the membrane system 106 and the outer strengthening system. Both layers 802, 804 in FIG. 8 are constructed from the same or similar type of material, such as plastic. Alternatively, the two layers 802, 804 may be constructed from different materials. The two layers may be produced using an extrusion technique that will produce an elongated sheet or film with one layer or side of the extrusion comprising the sealing film, and the other layer or side of the extrusion comprising the attachment layer. Alternatively, the two layers could be separately produced and then bonded together by gluing, lamination, or welding techniques or the like to form the material 800 for the membrane system 106. Bonding between the membrane system 106 and the outer strengthening system 108 may be achieved, for example, with the attachment layer 804 being configured with a textile or textured surface that can retain curable material in the attachment layer, for bonding with the outer strengthening system upon curing, or having a chemical property that ensures bonding to the outer strengthening system upon curing.

The two plastics 802, 804 illustrated in FIG. 8 are co-extruded and blown in a circumference specific to the pipe that is to be lined. That is, the width of the FIG. 8 membrane system is substantially equal to the inner circumference of the pipe. As noted above, alternative construction techniques may be used to produce the membrane system. Regardless of construction technique, the FIG. 8 membrane system must perform the same function for the membrane system embodiment as described previously. If the plastics 802, 804 are blown in a circumference specific to the pipe to be lined, then the plastics will not be formed in a sheet for folding, as described previously, and there will be no overlap area that permits relative movement between the sheet edges upon inflation. Therefore, for the FIG. 8 co-extruded and blown embodiment, the plastics 802, 804 must have sufficient pliability to conform to the inner surface of the pipe when the pipe liner is inflated, while still avoiding separation and pockets between the membrane system and outer strengthening system. Thus, the composition and thickness of the plastics must be selected to provide the requisite ability to stretch and conform to the pipe inner surface prior to curing.

The innermost plastic 802, which faces into the interior of the pipe and comes in contact with the gas or liquid being transported through the pipe, is configured to successfully carry the gases and liquids without suffering destructive effects. Thus, it should be sufficiently thick and hard to be abrasion resistant, and it should also be chemically resistant to the gas or liquid being transported. For most applications, the innermost plastic 802 should be heat resistant to at least the temperatures expected to be reached during the curing process. For use with outer strengthening systems that are UV-cured, the plastics 802, 804 should allow for the passage of UV light to the outer strengthening system with minimal diffusion.

As noted previously, the attachment layer 804 faces the outer strengthening system and has a construction or chemical property that ensures bonding to the outer strengthening system upon curing. The bonding ensures that the outermost plastic will not peel away from the outer strengthening system. In the illustrated embodiment of FIG. 8, the outermost plastic 804 forms a bond because it is reactive to styrenes or other chemicals so as to bond with the curable resin of the outer strengthening system when the resin is cured. It may be constructed with a more pliable and absorbent characteristic, again to encourage an effective bond with the curable material of the outer strengthening system. These characteristics of the outermost plastic 804 may be obtained by providing a surface texture of the plastic or by providing the plastic in a weave or mesh that holds (absorbs) the curable material. The two plastics 802, 804 can be extruded, which generally provides a better bond than laminating two plastics together. Extrusion can reduce the cost of producing the membrane system as compared with the cost of lamination operations for multiple layers.

Plastics that are suitable for the membrane system 800 include Thermoplastic Polyurethanes (TPUs). Polyester Polyurethane would likely be used in applications where hydrocarbons are carried in the pipe, and Polyether Polyurethane would likely be used in applications where water or sewage is carried in the pipe. Other plastics may also be suitable for the purposes described herein, such as Nylon 6 (a Polyamide), Isoplast, polytetrafluoroethylene (PTFE) such as DuPont Teflon™, and other materials not yet developed that have the properties described above.

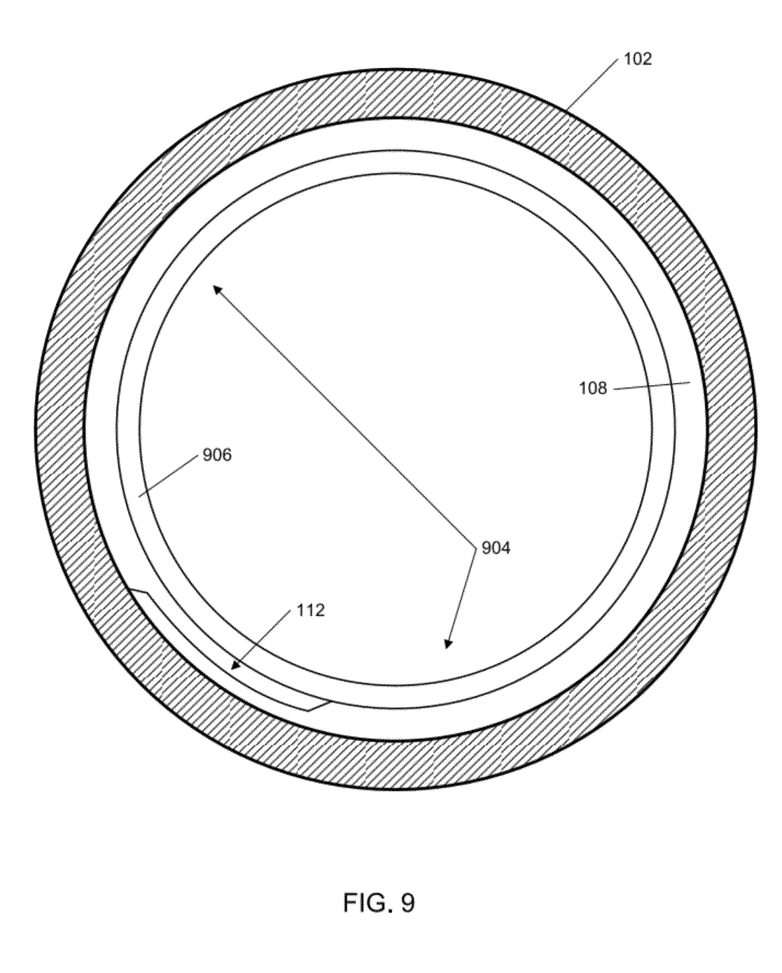

FIG. 9 is a cross-section through a pipe 102 with a cured liner tube 904 in place, shown in a hardened condition. The FIG. 9 liner tube has a membrane system 906 with substantially non-textured (e.g., smooth) outer surfaces, such as that illustrated for the membrane system portion 800 in FIG. 8. The FIG. 9 membrane system 906 is constructed of plastics that are blown in a circumference specific to the pipe to be lined, so there is no overlap area, and the plastics have sufficient pliability to conform to the inner surface of the pipe 102 when the pipe liner 904 is inflated prior to curing. For example, a blown membrane system may be produced by an extrusion process.

Upon curing, the membrane system 906 changes to the hardened condition and, because the membrane system conformed itself to the pipe inner surface upon inflation, the hardened membrane system is held fast against the outer strengthening system 108 in the hardened condition, without gaps or separation between the two. The membrane system may react with the outer strengthening system upon curing so as to bond with the outer strengthening system. The bonding may comprise a mechanical or chemical bond between the membrane system 906 and the outer strengthening system 108. For example, the bond may be provided by the hardening (curing) of the membrane system while conformed against the pipe inner surface, thereby holding fast against the outer strengthening system and mechanically maintaining the two systems in position within the pipe. Chemical bonding may include adhesives and the like. Other bonding techniques will be known to those skilled in the art. The FIG. 9 outer strengthening system 108 has a construction like that described above for FIG. 1. Thus, the schematic representation of FIG. 9 shows a portion 112 of the outer strengthening system 108 with overlapped sheets.

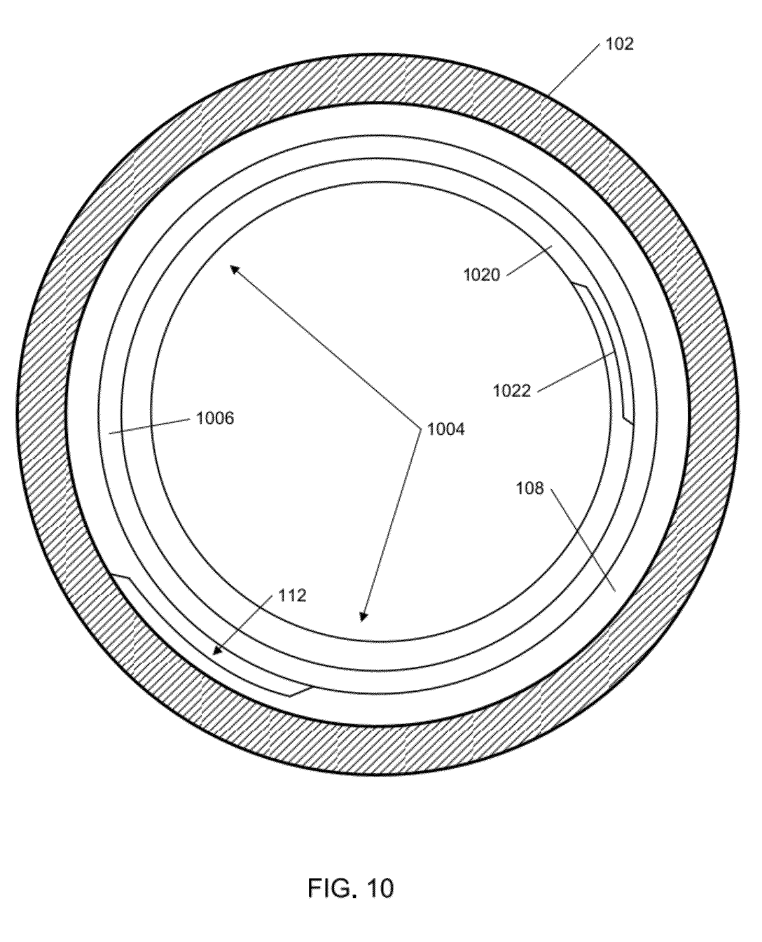

FIG. 10 is a cross-section through a pipe 102 with a cured liner tube 1004 in place, in which the liner tube has a membrane system 1006 with a homogeneous composition such as that illustrated in FIG. 8. The liner tube 1004 is shown in the hardened condition. As with the FIG. 9 membrane system 906, the FIG. 10 membrane system 1006 is constructed of plastics that are blown in a circumference specific to the pipe to be lined, so there is no overlap area, and the plastics of the membrane system 1006 have sufficient pliability to conform to the inner surface of the pipe 102 when the pipe liner 1004 is inflated prior to curing.

In the FIG. 10 embodiment, the bonding of the membrane system 1006 to the outer strengthening system 108 upon curing is ensured by an inner strengthening system 1020 that is constructed from multiple overlapped sheets having a construction similar to that of the outer strengthening system 108. The schematic representation of FIG. 10 shows a portion 1022 of the inner strengthening system 1020 with overlapped sheets. Details of the overlapped sheet construction are omitted from FIG. 10 for clarity but may be maintained together in the uncured condition as described above in connection with FIGS. 5 and 6, and will be understood by those skilled in the art. See also, for example, U.S. patent application Ser. No. 12/505,050 filed Jul. 17, 2009 in the name of R. Quitter for additional details of the overlapped construction.

In the condition prior to curing, the inner strengthening system 1020 is pliable, such that the liner tube 1004 comprising the outer strengthening system 108, membrane system 1006, and inner strengthening system 1020 can be placed within the pipe 102 and inflated with sufficient force so as to conform to the inner surface of the pipe. The inner strengthening system 1020 is then cured in the same manner and at the same time as the outer strengthening system. The outer strengthening system and the inner strengthening system may use the same technique and materials for curing, or they may use different techniques and materials for curing, depending on the desired characteristics.

Upon curing, the inner strengthening system 1020 changes to a hardened condition, as does the outer strengthening system 108, and the membrane system 1006 is held fast against the outer strengthening system. This ensures no separation and no pockets between the membrane system and the outer strengthening system. The FIG. 10 outer strengthening system 108 has a construction like that described above for FIG. 1. Thus, the schematic representation of FIG. 10 shows a portion 112 of the outer strengthening system 108 with overlapped sheets. The membrane system 1006 is effectively bonded to the outer strengthening system by the hardened inner strengthening system 1020. That is, the liner tube can perform its function with a “cold joint” between the membrane system and the outer strengthening system. As a result, the membrane system 1006 can take many forms and compositions, so long as the impermeable characteristic is maintained. For example, there is no need to ensure that the membrane system can retain curable material in an attachment layer for bonding with the outer strengthening system upon curing, and there is no need to ensure that the membrane system has a chemical property that ensures bonding to the outer strengthening system upon curing.

Welding Techniques

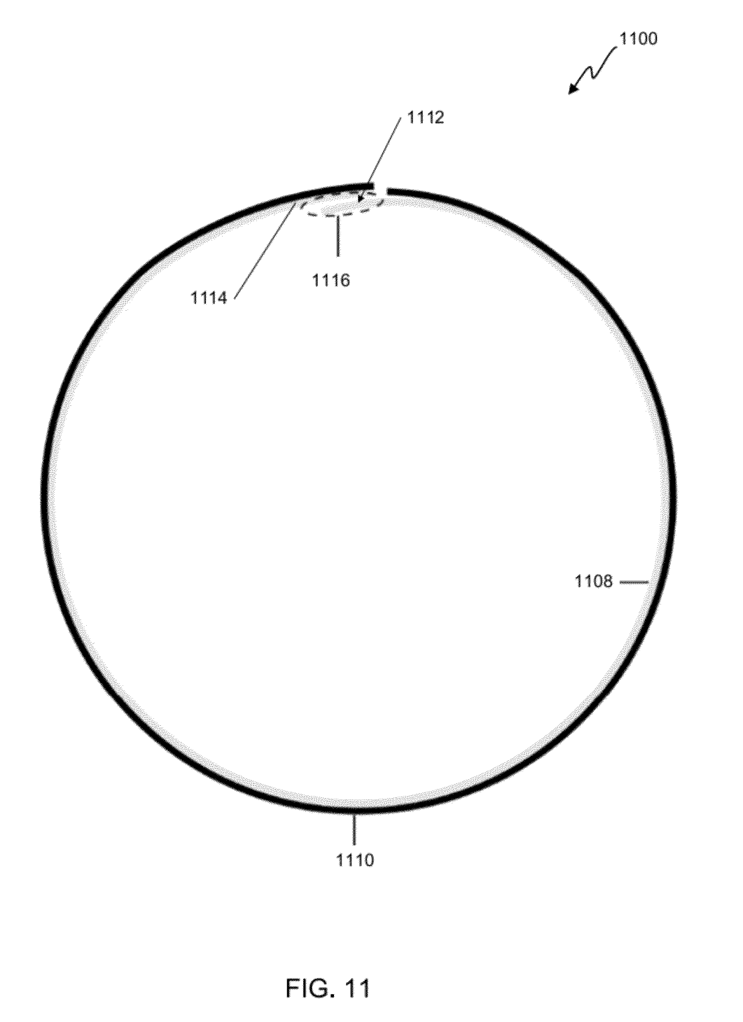

FIG. 11 is a cross-section of a membrane system showing a welding technique for the curable liner tube. FIG. 11 shows the membrane system 1100 having a sealing film 1108 bound to an attachment layer 1110. FIG. 11 depicts the membrane system in an inflated condition, prior to hardening, and without the associated liner tube components such as the outer strengthening system, for simplicity of illustration. When in place within a pipe, the attachment layer will be adjacent the inner surface of the strengthening system, and the sealing film will face toward the interior of the pipe. The sealing film 1108 extends beyond a longitudinal edge of the attachment layer 1110 in a bare overlap portion 1112, such that the overlap portion is adjacent an inward-facing surface area 1114 of the sealing film. The bare overlap portion 1112 may be produced during production of the membrane system 1100, or may be received from a vendor in the configuration as described with the exposed overlap portion 1112, as will be known to those skilled in the art. As noted above in connection with FIGS. 5-10, welding techniques may be used to ensure that the membrane system layers 1108, 1110 are maintained in proper configuration during handling, prior to inflation and hardening.

FIG. 11 illustrates a welding technique in which the bare overlap portion 1112 of the sealing film 1108 is exposed to the inward-facing area 1114 so that the bare overlap portion 1112 of the sealing film may be welded to the inward-facing surface area 1114 of the sealing film. In this context, “welding” refers to locally heating the sealing film along the bare overlap portion 1112 such that the exposed portion of the sealing film becomes partially molten so as to fuse with the adjacent sealing film. The area of melting and fusing is indicated in FIG. 11 by dashed lines 1116. That is, the melting and fusing forms a weld 1116 that maintains the overlapped sealing film 1108 in a closed condition prior to hardening. The attachment layer 1110 is sized so that its edges along its length will substantially butt up against each other when in position within the pipe. That is, for the FIG. 11 embodiment, the width of the attachment layer is substantially equal to the inner circumference of the strengthening system when installed.

The welding of one edge of the sealing film to the other is achieved according to the composition of the sealing film. The sealing film can generally be fused together by applying energy in the form of thermal, optical, or chemical energy, in accordance with the sealing film composition. For example, the sealing film 1108 may have a plastic composition, in which case the welding may be achieved by heating the sealing film to the melting point of the plastic. In this way, the welding may be achieved without the need for a welding filler material.

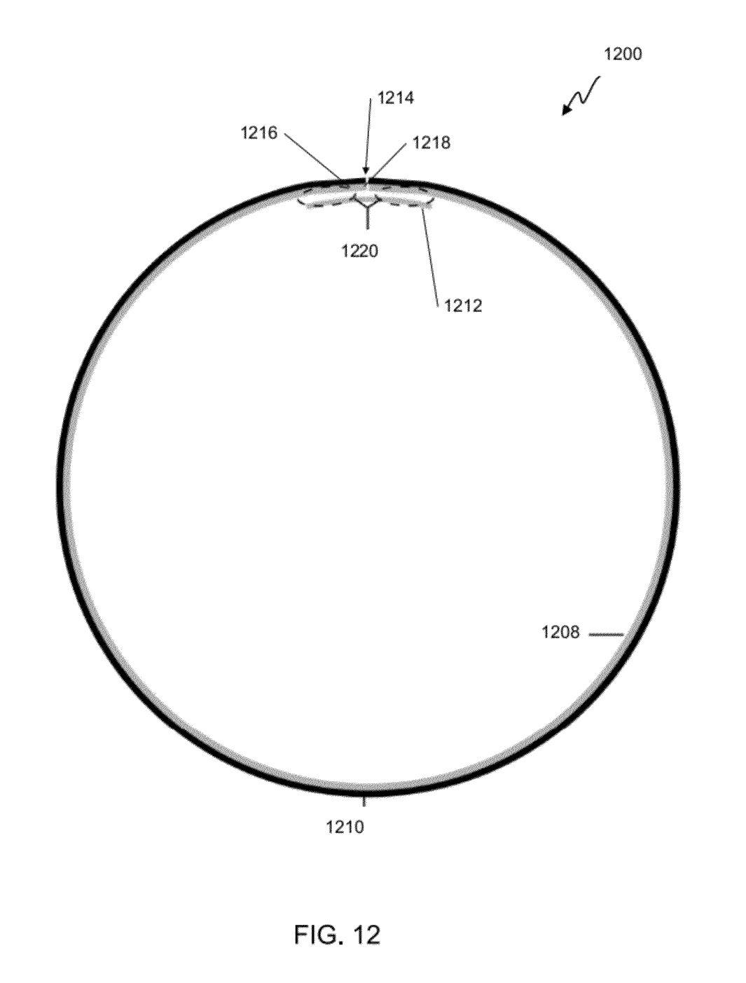

FIG. 12 is a cross-section of a membrane system showing an alternative welding technique for the curable liner tube. FIG. 12 shows the membrane system 1200 having a sealing film 1208 bound to an attachment layer 1210. FIG. 12 depicts the membrane system in an inflated condition, prior to hardening, and without the associated liner tube components such as the outer strengthening system, for simplicity of illustration. When in place within a pipe, the attachment layer will be adjacent the inner surface of the strengthening system, and the sealing film will face toward the interior of the pipe. FIG. 12 illustrates a welding technique alternative to that depicted in FIG. 11. The FIG. 12 embodiment does not involve a bare overlap portion of the sealing film that extends beyond a longitudinal edge of the attachment layer 1210. Instead, both the attachment layer 1210 and the sealing film 1208 in FIG. 12 are sized so that their respective edges along the length of the liner tube will substantially butt up against each other when in position within the pipe. That is, for the FIG. 12 embodiment, the width of the attachment layer and the sealing film are approximately the same and are substantially equal to the inner circumference of the of the strengthening system when installed.

In the FIG. 12 embodiment, an elongated strip 1212 of the sealing film is positioned so as to overlap the seam 1214 where the two edges of the membrane system meet, on the surface of the sealing film that faces inwardly toward the pipe interior. This construction provides a homogeneous composition of adjacent surfaces for the welding. The strip 1212 is fastened across the two edges 1216, 1218 of the sealing film by welding as described above. In FIG. 12, the weld 1220 is indicated by dashed lines. The weld 1220 is indicated as having separate portions, one along each respective edge of the sealing film 1216, 1218, but it should be understood that the weld 1220 can be implemented as a single weld (i.e., a single area of melted and fused sealing film) or as a weld comprising two separate areas of melted and fused sealing film. As with the FIG. 11 embodiment, various types of energy may be applied to achieve the welding, including thermal, optical, and chemical energy. For most applications, with respect to withstanding typical pipe pressures and diameters, sufficient performance for handling prior to curing may be obtained by providing approximately at least 0.5 inch (1.25 cm) in width extending along each joined portion of the sealing film. Attaching the strip 1212 along the interior of the seam 1214 can be achieved with available equipment using known techniques. For example, Miller Weldmaster Corporation of Navarre, Ohio, USA provides fabric welding machinery that is capable of producing the FIG. 12 embodiment described herein.

The welding techniques depicted in FIG. 11 and FIG. 12 can provide fastening of the membrane system edges together that remains secure during handling. One contributing factor to the secure fastening is that the resin that is typically embedded or infused into the attachment layer will not typically bond to the sealing film. The lack of an easily achieved good bond between the attachment layer and sealing film means that overlapped configurations of the membrane system are not as easily maintained in proper position during handling. The welding techniques of FIG. 11 and FIG. 12 can avoid this difficulty.

Features of the Disclosure

Manufacturing Method

The membrane system sheets are either taped in place with tape configured to dissolve when it comes in contact with the resin, or the textile fabric is saturated with resin, or both. The tape eases handling during manufacture, so that the layers are more easily manipulated while being folded.

Reasons for Overlap

The membrane system 106 is overlapped for the same reason the outer strengthening system 108 is overlapped; to allow expansion during liner inflation, which assures conformity with the interior of the host pipe that is being lined. That is, the layer edges along the overlap seam can move apart during inflation to conform with the interior of the pipe, while the overlap ensures that no gaps will occur in the seam, providing a secure seal. The membrane system is taped, welded, or glued with a material that will dissolve from resin to make sure the membrane system stays aligned during the wetting out process, but the point of attachment is narrow so that resin is allowed to migrate into the overlap area from above and below (i.e., inside and outside the seam edge). The weld or glue may be configured to give way upon inflation, such as a temporary weld to give way upon inflation or a glue that dissolves or is sufficiently elastic to give way upon inflation. In addition, the plastic can stretch during inflation and conform to the interior surface of the pipe. The wetting out (applying the curable resin to the material layers) may occur at a production site for the curable pressure pipe liner or may occur at a post-production distribution site or job site. Alternatively, resin can be applied instead of the tape or in addition to the tape to ensure that the overlap seam area is fully saturated without having to rely on resin migration for complete coverage in the seam area.

After curing, the resin is bonded to the inner side, the outer side, and the overlap area of the membrane system, changing into a hardened condition and resulting in a fully bonded, pressure and abrasion resistant, one-piece structural pipe lining.

While the principles of the disclosure have been described above in connection with specific apparatuses and methods, it is to be clearly understood that this description is made only by way of example and not as limitation on the scope of the disclosure.

We claim:

1. A liner tube having sufficient pliability to lie substantially flat in an uncured condition and to be substantially circular in cross section in an expanded state, the liner tube comprising:
an outer strengthening system comprising a curable material that is configured for placement in a pipe interior and that changes to a hardened condition upon curing; and
a membrane system disposed inwardly relative to the outer strengthening system when placed in the pipe interior, comprising an impermeable sealing film having a facing surface that faces the interior of the pipe.

2. A liner tube as in claim 1, wherein the impermeable sealing film comprises a plastic material.

3. A liner tube as in claim 2, wherein the impermeable sealing film plastic material has an inner surface and an outer surface, and the membrane system further includes an attachment layer that comprises a textile layer placed on at least one surface of the plastic material.

4. A liner tube as in claim 1, wherein the membrane system includes at least one textile layer.

5. A liner tube as in claim 4, wherein the textile layer includes a curable material that changes from a pliable condition to a hardened condition upon curing.

6. A liner tube as in claim 4, wherein the textile layer comprises a hydroentangled fabric (HEF) material.

7. A liner tube as in claim 1, wherein the outer strengthening system comprises at least one fiberglass sheet.

8. A liner tube as in claim 1, wherein the outer strengthening system includes a curable material that changes from a pliable condition to a hardened condition upon curing.

9. A liner tube as in claim 1, further including a fleece layer disposed around the outer strengthening system.

10. A liner tube as in claim 1, wherein the impermeable sealing film comprises a sheet material with an overlapped seam area.

11. A liner tube as in claim 10, wherein the overlapped seam area is maintained in a closed condition prior to curing by a sealant.

12. A liner tube as in claim 11, wherein the sealant includes an adhesive.

13. A liner tube as in claim 11, wherein the sealant includes a tape.

14. A liner tube as in claim 1, wherein the membrane system reacts with the outer strengthening system upon curing to bond with the outer strengthening system.

15. A liner tube as in claim 14, further including an inner strengthening system wherein the membrane system, disposed inwardly relative to the membrane system when placed in the pipe interior, and comprising a curable material that changes from a pliable condition to a hardened condition upon curing.

16. A liner tube as in claim 1, wherein the membrane system comprises an elongated attachment layer and an elongated sealing film such that the sealing film has a width in the substantially flat uncured condition that is greater than the width of the attachment layer such that one edge of the sealing film is laid over the other edge of the sealing film in an overlapped seam area.

17. A liner tube as in claim 16, wherein the overlapped seam area is maintained in a closed condition prior to curing by a sealant.

18. A liner tube as in claim 16, wherein the overlapped seam area is maintained in a closed condition prior to curing by a weld.

19. A liner tube as in claim 16, wherein the attachment layer has a width in the substantially flat uncured condition that is substantially equal to the inner circumference of the strengthening system when installed.

20. A liner tube as in claim 1, wherein the membrane system comprises an elongated attachment layer and an elongated sealing film that the attachment layer and the sealing film have a width in the substantially flat uncured condition that is substantially equal to the inner circumference of the strengthening system when installed such that the edges of the attachment layer and sealing film meet along a seam, and the membrane system further comprises an elongated strip positioned so as to overlap the seam where the two edges of the membrane system meet, wherein the strip is maintained in position prior to curing by a weld.

21. A liner tube as in claim 1, wherein the membrane system comprises an elongated attachment layer and an elongated sealing film that the sealing film has a width in the substantially flat uncured condition that is greater than the pipe interior circumference such that one edge of the sealing film is laid over the other edge of the sealing film in an overlapped seam area.

22. A liner tube as in claim 21, wherein the attachment layer has a width in the substantially flat uncured condition that is substantially equal to the inner circumference of the strengthening system when installed.
